(19) United States
(12) Patent Application Publication
(10) Pub. No.: US 2020/0241726 A1
(43) Pub. Date: Jul. 30, 2020

(54) METHODS AND APPARATUS FOR A TOUCH SENSOR

(71) Applicant: SEMICONDUCTOR COMPONENTS INDUSTRIES, LLC, Phoenix, AZ (US)

(72) Inventors: Tetsuya TOKUNAGA, Oura-gun (JP); Kensuke GOTO, Ashikaga (JP); Hiroshi YOSHINO, Oizumi-machi (JP); Yasunori YAMAMOTO, Ora-gun (JP); Takayasu OTAGAKI, Ota (JP)

(73) Assignee: SEMICONDUCTOR COMPONENTS INDUSTRIES, LLC, Phoenix, AZ (US)

(21) Appl. No.: 16/677,837

(22) Filed: Nov. 8, 2019

Related U.S. Application Data
(60) Provisional application No. 62/796,906, filed on Jan. 25, 2019.

(51) Int. Cl. G06F 3/041; G06F 3/044

(52) U.S. Cl. CPC G06F 3/04186; G06F 3/044

(57) ABSTRACT

Various embodiments of the present technology may provide methods and system for a touch sensor. The system may provide a sensing circuit connected to a touch sensor comprising a plurality of capacitive sense elements. The sensing circuit detects changes in the touch sensor and interprets whether the change represents a touch event or a non-touch event.

### CROSS-REFERENCE TO RELATED APPLICATION

This application claims the benefit of U.S. Provisional Patent Application Ser. No. 62/796,906, filed on Jan. 25, 2019, the contents of which are incorporated by reference.

### BACKGROUND OF THE TECHNOLOGY

Mutual capacitive touch sensors operate by measuring and detecting changes in the capacitance formed between a transmission electrode and a sense electrode. Typically, a change in capacitance indicates a touch or presence of a conductive object. When the conductive object (e.g., a finger) comes near and/or in contact with the touch sensor, the electric field formed between the transmission and sense electrodes is disrupted, resulting in a change in the capacitance of the sense electrode. An electrical circuit (a sensing circuit) may be utilized to measure the change in capacitance of the touch sensor, and the electrical circuit may convert the measured capacitance of the touch sensor into a voltage and/or digital value to represent a touch event and a non-touch event (no touch).

In some cases, a device may have multiple touch sensors located in close proximity to each other. In such cases, the sensing circuit may indicate that more than one touch sensor has experienced a touch event, when in reality only one should indicate a touch event. Conventional detection circuits resolve these mis-detections (i.e., false positives) by performing additional processing, which requires additional memory, and thus increases the cost and complexity of the device.

### SUMMARY OF THE INVENTION

Various embodiments of the present technology may provide methods and system for a touch sensor. The system may provide a sensing circuit connected to a touch sensor comprising a plurality of capacitive sense elements. The sensing circuit detects changes in the touch sensor and interprets whether the change represents a touch event or a non-touch event.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIGS. 1A-1B is a block diagram of touch sensor system;

FIG. 2A representatively illustrates an object at a first position relative to a touch sensor in accordance with a first embodiment;

FIG. 2B is a data chart with example data provided by a sensing circuit when the object is at the first position in accordance with the first embodiment;

FIG. 3A representatively illustrates the object at a second position relative to the touch sensor in accordance with the first embodiment;

FIG. 3B is a data chart with example data provided by the sensing circuit when the object is at the second position in accordance with the first embodiment;

FIG. 4A representatively illustrates two objects at a first position and a second position relative to a first touch sensor and a second touch sensor, respectively, in accordance with a second embodiment;

FIG. 4B is a data chart with example data provided by a sensing circuit when the object is at the first and second positions in accordance with the second embodiment;

FIG. 5A representatively illustrates two objects at a third position and a fourth position relative to a first touch sensor and a second touch sensor, respectively, in accordance with the second embodiment;

FIG. 5B is a data chart with example data provided by a sensing circuit when the object is at the third and fourth positions in accordance with the second embodiment;

FIG. 6A representatively illustrates an object at a first position relative to a touch sensor in accordance with a third embodiment;

FIG. 6B is a data chart with example data provided by a sensing circuit when the object is at the first position in accordance with the third embodiment;

FIG. 7A representatively illustrates an object at a second position relative to a touch sensor in accordance with the third embodiment;

FIG. 7B is a data chart with example data provided by a sensing circuit when the object is at the second position in accordance with the third embodiment;

FIG. 8 is a circuit diagram of an amplifier circuit in accordance with the present technology; and

FIG. 9 is a flow chart for operating a sensing circuit in accordance with an embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various types of conductors, semiconductors, capacitors, electrodes, signal generators, multiplexers, converters, amplifiers, registers, detectors, controllers, comparators and the like, which may carry out a variety of functions. In addition, the present technology may be practiced in conjunction with any number of applications, and the apparatus described is merely one exemplary application for the technology. In addition, the present technology may be integrated in any number of electronic systems, such as automotive, aviation, “smart devices,” portables, “white goods,” and consumer electronics, and the systems described are merely exemplary applications for the technology. Further, the present technology may employ any number of conventional techniques for sensing, detecting, routing, storing, reading, writing, converting, amplifying, controlling, comparing and the like, and may employ any number of materials.

The methods and system according to various aspects of the present technology may be used in conjunction with any electronics for touch sensing with a cross talk problem and/or mis-detection of a touch event. Various representative implementations of the present technology may be applied, for example, to any capacitive touch systems, such as a touch screen and or any other system with a series of touch buttons. Alternative embodiments may be applicable to non-capacitive touch sensors, such as resistive, surface acoustic wave, infrared, optical imaging, or acoustic pulse recognition touch sensors.

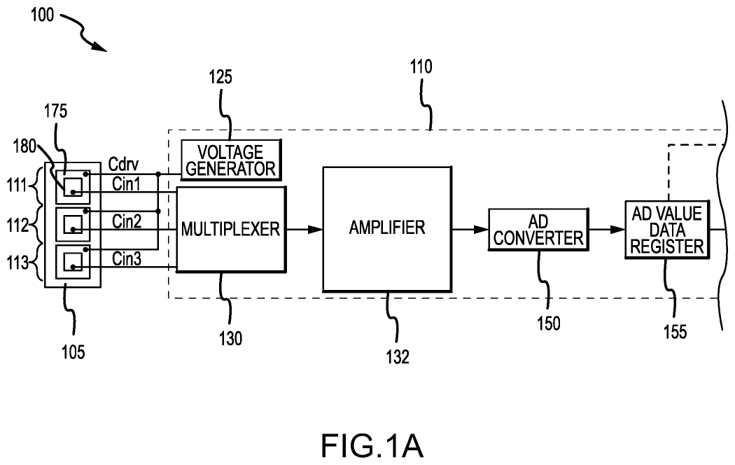

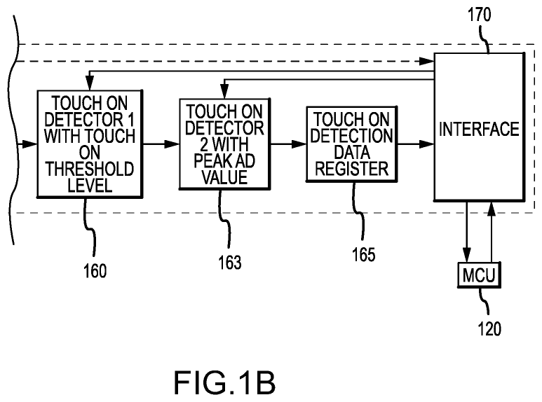

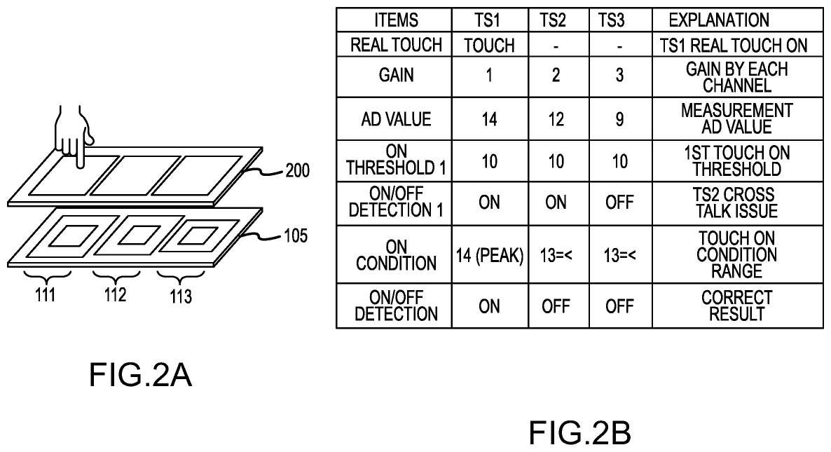

Referring to FIGS. 1A-1B and 2A, an exemplary touch sensor system 100 may be integrated in an electronic device, such as a cell phone or computer, to detect proximity, gestures, touch, pressure, and the like. In an exemplary embodiment, the touch sensor system 100 may comprise a touch pad 105, a sensing circuit 110, and a controller (MCU) 120.

The touch pad 105 may be configured to detect an object, such as a hand or finger. For example, the touch pad 105 may operate in conjunction with the sensing circuit 110 to determine a direct touch, a position, a proximity, a gesture, and/or an applied pressure of the object relative to the touch pad 105.

According to an exemplary embodiment, the touch pad 105 may comprise a plurality of capacitive touch sensors, such as a first touch sensor 111 (TS1), a second touch sensor 112 (TS2), and a third touch sensor 113 (TS3). The touch pad 105 may comprise any number of touch sensors. Each touch sensor may be configured as a mutual capacitance sensor and may comprise a first electrode 175 in communication with a second electrode 180.

The first and second electrodes 175, 180 may be configured to form an electric field, wherein a capacitance of each touch sensor is proportional to the electric field. For example, one electrode may operate as a drive electrode (i.e., a transmission electrode) while the remaining electrode may operate as a reception electrode. The first and second electrodes 175, 180 may be formed using a conductive material, such as metal or any other suitable conductive material. Either one of the first and second electrodes 175, 180 may be connected to a power source 125 or voltage generator that generates a drive signal Cdrv. The drive signal Cdry may pulse between two voltage levels. Accordingly, the electrode that is connected to the power source 125 may be referred to as the drive electrode and the remaining electrode may be referred to as the reception electrode (i.e., a sense electrode).

In an exemplary embodiment, the first and second electrodes 175, 180 may be arranged as concentric squares, circles, or any other suitable shape, and the first and second electrodes 175, 180 may be planar with each other. In other words, one electrode, such as the second electrode 180 may be nested within the other electrode, such as the first electrode 175. The first and second electrodes 175, 180 may be formed on a flexible substrate, such as a plastic material, or a rigid substrate, such as a printed circuit board.

In various embodiments, each touch sensor from the plurality of touch sensors may have a different size (i.e., area) from the remaining touch sensors. For example, the first touch sensor 111 may be the largest among the first, second, and third touch sensors, the third touch sensor 113 may be the smallest among the first, second, and third touch sensors, and the second touch sensor 112 may have a mid-size that is between the first and third touch sensors 111, 113.

In various embodiments, the touch pad 105 may comprise a membrane 200 or other suitable cover, such as a flexible plastic that covers and protects the electrodes 175, 180. An air gap may exist between the membrane and the touch sensors 111, 112, 113. The membrane may also indicate the particular location of the touch sensors on the touch pad 105. For example, the membrane may be marked with text, boarders, or other indicators that correspond to one touch sensor.

The sensing circuit 110 may be responsive to the electric field and/or configured to measure the capacitance and/or a change in capacitance of each touch sensor 111, 112, 113. For example, the sensing circuit 110 may respond to a first capacitance Cin1 associated with the first touch sensor 111, a second capacitance Cin2 associated with the second touch sensor 112, and a third capacitance Cin3 associated with the third touch sensor 113. When the object approaches the touch pad 105 and/or the touch sensors, the object disturbs the electric field which causes a change to a resting capacitance (i.e., the capacitance of the touch sensors in the absence of a conductive object).

The sensing circuit 110 may be used to resolve cross talk (electrical interference) between two or more touch sensors, which may result in false positives (i.e., mis-detections) for one or more of the touch sensors. For example, as the object touches the touch pad 105, there is a change in capacitance in the touch sensor that is directly touched. In some cases, in particular, when the touch sensors 111, 112, 113 are located in close proximity to each other, there may also be a change in capacitance in one or more adjacent touch sensors. The change in capacitance of the adjacent touch sensors that are not touched may still indicate a touch event, which may be referred to a false positive or mis-detection.

The sensing circuit 110 may be constructed of any suitable electronic devices, such as conductors, capacitors, inductors, resistors, semiconductors, switches, transistors, operational amplifiers, potentiometers, logic gates, and the like. In various embodiments, the sensing circuit 110 may operate in conjunction with a variety of circuits or channels with cross talk problems, including problems from undesired capacitive, inductive, or conductive coupling.

According to an exemplary embodiment, the sensing circuit 110 may be further configured to perform various functions, such as amplification, signal conversion, signal analysis, and the like. For example, the sensing circuit 110 may comprise an amplifier 132, an analog-to-digital converter (ADC) 150, a first detection circuit 160, and a second detection circuit 163. The sensing circuit 110 may further comprise various circuits and/or devices for transmitting and/or storing data. For example, the sensing circuit 110 may comprise a multiplexer 130, a first register 155, and a second register 165.

The multiplexer 130 may be connected to the touch pad 105 to receive a plurality of input signals from the touch sensors (e.g., signals Cin1, Cin2, Cin3). For example, each touch sensor may generate a respective input signal and may be separately (individually) connected to the multiplexer 130. The multiplexer 130 may selectively transmit one signal from the plurality of input signals to the first amplifier circuit 132. The multiplexer 130 may comprise a conventional multiplexer circuit or any other circuit suitable for selectively transmitting signals from multiple input terminals to at least one output terminal.

The amplifier 132 may be configured convert the input signals (e.g., Cin1, Cin2, Cin3) to a voltage value and to apply different gain values to each voltage of the various touch sensors. For example, a small gain value may be applied to a voltage of the largest-sized touch sensor (e.g., the first touch sensor 111), a large gain value (relative to and less than the small gain) may be applied to a voltage of the smallest-sized touch sensor (e.g., the third touch sensor 113), and a mid-gain value (i.e., a gain level between the large and small gain values) may be applied to a voltage of the mid-sized touch sensor (e.g., the second touch sensor 112).

In embodiments where all the touch sensors are same-sized, the amplifier 132 may apply a same gain to each voltage.

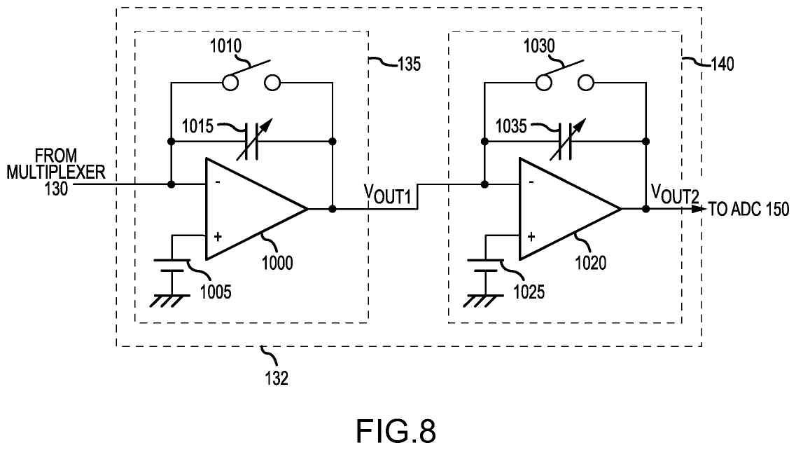

Referring to FIG. 8, the amplifier 132 may comprise a first amplifier circuit 135 and a second amplifier circuit 140. The first amplifier circuit 135 may be configured to measure the capacitance and/or detect changes in the capacitance and convert the capacitance (e.g., Cin1, Cin2, Cin3) to a voltage. For example, the first amplifier circuit 135 may comprise a first differential amplifier 1000 comprising an inverting terminal (−) connected to the multiplexer 130 (FIG. 1A) and a non-inverting terminal (+) connected to a reference voltage, such as supplied by a first voltage source 1005. The first differential amplifier 1000 may be configured to measure a voltage difference between the inverting and non-inverting terminals. The first differential amplifier 1000 may also be configured to amplify a signal by applying a gain to the voltage difference and generate a first output voltage V_{OUT1} according to the voltage difference and/or the applied gain.

The second amplifier circuit 140 may be configured to amplify a signal. For example, the second amplifier circuit 140 may be connected to an output terminal of the first amplifier circuit 135 and configured to apply a gain to the first output voltage V_{OUT1} and generate a second output voltage V_{OUT2} according to the applied gain. The second amplifier circuit 140 may comprise a second differential amplifier 1020 comprising an inverting terminal (−) connected to the output terminal of the first amplifier circuit 135 and a non-inverting terminal (+) connected to a reference voltage, such as supplied by a second voltage source 1025. The first and second voltage sources 1005, 1025 may supply a same voltage, such as 0.5 V.

The first and second amplifier circuits 135, 140 may each have different gains, and the gain of each amplifier may be changed at any time using a variable capacitor, such as a first variable capacitor 1015 connected to the first amplifier circuit 135 and a second variable 1035 connected to the second amplifier circuit 140.

Referring back to FIGS. 1A-1B, the ADC 150 may be connected to an output terminal of the second amplifier circuit 140 and configured to convert a voltage, such as the second output voltage V_{OUT2}, to a digital value (i.e., AD value). According to various embodiments, as the capacitance of the touch sensor decreases, the corresponding digital value increases and vice versa. The ADC 150 may comprise any signal converter suitable for converting an analog signal to a digital signal.

The ADC 150 may transmit the digital value to the first register 155, wherein the first register 155 stores the digital value. The first register 155 may comprise any memory device suitable for storing data, digital values, and the like.

The first detection circuit 160 may receive the digital value from the ADC 150 via the first register 155 and interpret the digital value. According to various embodiments, the first detection circuit 160 may be programmed with a first threshold value that corresponds to a pre-defined digital value. The first detection circuit 160 may utilize the first threshold value to determine whether a touch event (e.g., actual contact between the object and the touch sensor and/or disturbances of the electric field by the object), has occurred. For example, the first detection circuit 160 may compare the digital value from the ADC 150 with the first threshold value and generate a first logic signal corresponding to the comparison. The first logic signal may have a first value (e.g., a logic ‘0’ value) if the digital value is less than the first threshold value and may have a second value (e.g., a logic ‘1’ value) if the digital value is greater than or equal to the first threshold. The first threshold value may be a predetermined value based on the particular application, size of the touch sensor, desired sensitivity, and the like. The first value may indicate an absence of a touch event (OFF condition, non-touch event) and the second value may indicate a presence of a touch event (ON condition). The first detection circuit 160 may comprise any number of circuits, logic gates, and the like, that operate together to analyze the digital value to determine whether a touch event has occurred. The first detection circuit 160 may transmit the digital value that corresponds to a touch event to the second detection circuit 163, where the digital values are further analyzed.

The second detection circuit 163 may receive one or more digital values from the first detection circuit 160 and interpret the digital values to determine which digital value has the largest magnitude of the one or more digital values. According to various embodiments, the second detection circuit 163 may be programmed with a set of second thresholds values (i.e., a range of values and/or a minimum value and maximum value) that corresponds to particular digital values. One or more of the values from the set of second threshold values may be predetermined values based on the particular application, size of the touch sensor, desired sensitivity, and the like.

The second detection circuit 163 may utilize the set of second threshold values to determine whether the one or more digital values from the first detection circuit 160 is within the range of the set of second threshold values. For example, if the second detection circuit 163 receives two digital values, the second detection circuit 163 may compare the values to the set of second thresholds (or range of values) and determine which digital value is within the desired range of values. The second detection circuit 163 may then generate a second logic signal corresponding to the comparison. For example, the second logic signal may have a first value (e.g., a logic ‘0’ value) if the digital value is outside of the range of values and may have a second value (e.g., a logic ‘1’ value) if the digital value is within the range of values. The first value may indicate an absence of a touch event (OFF condition) and the second value may indicate a presence of a touch event (ON condition).

The second detection circuit 163 may transmit the second logic value to a second register 165, wherein the second register 165 stores the second logic value. The second register 165 may comprise any memory device suitable for storing data, digital values, and the like.

The first and second detection circuits 160, 163 may comprise any suitable circuit and/or systems. For example, each may comprise a comparator circuit configured to compare the digital values output from the digital value register to one or more predetermined threshold values. Alternatively, the first and second detection circuit 160, 163 may be configured to compare the digital values output from the digital value register 155 to a dynamically changing threshold value. For example, the first and second detection circuit 160, 163 may receive an external control signal from the MCU 120 indicating changes to the threshold values.

The touch sensor system 100 may further comprise an interface 170 configured to communicate with the MCU 120, the first register 155, the second register 165, the first detection circuit 160, and the second detection circuit 163. For example, the interface 170 may be configured to send and/or receive data and/or other control information to/from the MCU 120, such as touch detection data, gain control information, threshold information, and the like.

The interface 170 may transmit a gain signal to each amplifier circuit 135, 140 to control or otherwise adjust the gain for each amplifier 135, 140. The interface 170 may operate in conjunction with the MCU 120 to adjust or control the gain dynamically (in real time).

The interface 170 may also communicate with the first register 155. For example, the interface 170 may retrieve or otherwise receive data stored in the first register 155. The interface 170 may further control the first and second detection circuits 160, 163, such as by setting various threshold values or ranges used to determine whether a touch event has occurred.

The MCU 120 may determine the various thresholds set by the first and second detection circuit 160, 163. For example, the MCU 120 may set the thresholds based on the most recent data from the first register 155 and/or the second register 165. The MCU 120 may utilize the magnitudes of the digital values at any given time to determine the thresholds and/or the range of values. As such, the thresholds and/or range of values may change over time based on the magnitudes of the digital values.

The MCU 120 may be configured to analyze a set of logic values and determine at least one of a position and a proximity of the object in relation to the touch pad 105 and/or particular touch sensors. For example, the MCU 120 may utilize the set of logic values to determine which touch sensor is closest to the object. The MCU 120 may also estimate the object's distance from a surface of the touch pad 105 and/or a particular touch sensor. The MCU 120 may comprise various circuits and/or devices suitable for analyzing the set of logic values in combination with each other, such as a microcontroller (MCU), field programmable gate array, or other logic circuit.

In various operations, the sensing circuit 110 may transform a signal (e.g., an input capacitance) from a touch sensor to a voltage signal, convert the voltage signal to digital value data, store the digital value data, detect at least one touch event by comparing the digital value data to a first threshold value, determine a set of ON conditions using a peak value and secondary value and determine if any of the digital values meets the ON condition criteria, generate an ON signal, store the ON signal, and process the ON signal and its corresponding digital value data.

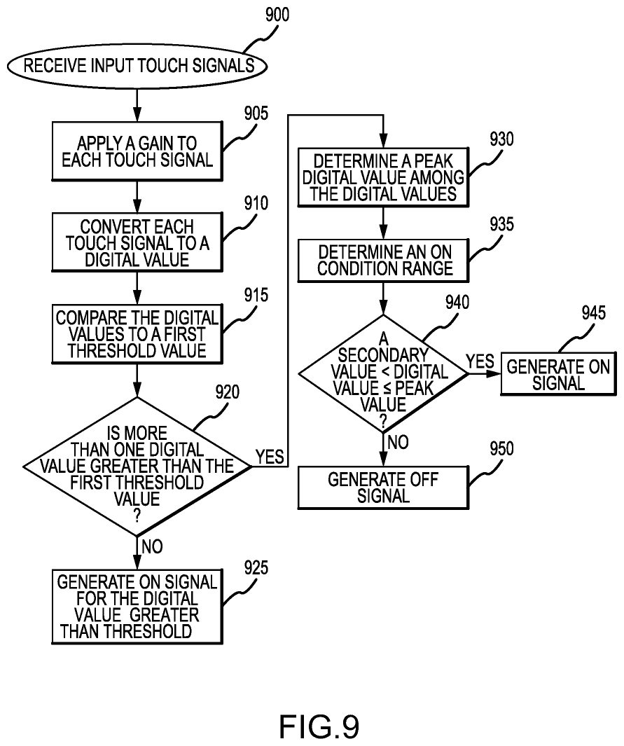

In various operations, the sensing circuit 110 may operate to prevent false positives (i.e., false ON conditions, mis-detections) among the various touch sensors due to cross talk. The sensing circuit 110 may utilize multiple threshold values and/or a set of ON conditions and/or an ON range with different values to prevent false positives. For example, and referring to FIGS. 1A-1B and 9, the sensing circuit 110 may receive the input signals (e.g., Cin1, Cin2, Cin3) from the touch pad 105 (900). The sensing circuit 110 may then apply a gain value to each input signal (905), for example using the amplifier 132, and convert each input signal to a digital value (910), for example using the ADC 150. The sensing circuit 110 may then compare each digital value to a first threshold value (915) and determine if more than one of the digital values is greater than the first threshold value (920). If only one of the digital values is greater than the first threshold value, then the sensing circuit 110 may generate an ON signal (indicting a touch event for the corresponding touch sensor) for that digital signal that is greater than the first threshold value (925). If more than one digital value is greater than the first threshold value, then the sensing circuit 110 may determine the peak value (highest magnitude value) among the digital values (930). Using the peak value, the sensing circuit 110 and/or the MCU 120 may then determine an ON condition range, wherein a touch sensor is considered to be ON (touched) if the corresponding digital value falls within a particular range of values. In various embodiments, the range includes the peak value and a secondary value (which is less than the peak value). For example, if the digital value is greater than the secondary value and less than or equal to the peak value (940), then the sensing circuit 110 generates the ON signal (945). If the digital value does not meet the ON condition criteria, then the sensing circuit 110 generates an OFF signal (indicating a non-touch event).

In a first exemplary operation and referring to FIGS. 1A-1B, 2A-2B, and 3A-3B, the sensing circuit 110 may compare the digital values to a first threshold value, and then compare the digital values for those corresponding to a touch event to the ON conditions. If the digital value does not meet the ON conditions, an OFF signal representing a non-touch event (e.g., a logic value ‘0’) is generated, and if the digital value meets the ON conditions, then a signal representing a touch event (e.g., a logic value ‘1’) is generated. According to the present operation, the MCU 120 may determine the ON condition by setting a peak value first and then setting one or more secondary values based on the peak value, wherein the secondary values are less than the peak value.

For example, and referring to FIGS. 1A-1B and 2A-2B, the finger approaches/touches the first touch sensor 111. The amplifier 132 applies a gain value of 1 to the first input signal Cin1, a gain value of 2 to the second input signal Cin2, and a gain value of 3 to the third input signal Cin3. In the present example, the resulting digital values are 14, 12, and 9, respectively. The first detection circuit 160 then compares the digital values (e.g., 14, 12, and 9) to a threshold value of 10 and based on that comparison, indicates that the first and second touch sensors have been touched (ON). Next, the second detection circuit 163 determines a peak value (e.g., 14), based on the highest magnitude digital value, and a secondary value (e.g., 13) and compares the digital values (e.g., 14, 12, and 9) to the peak value and the secondary value. The second detection circuit 163 may then determine if the digital values are within the ON range (i.e., whether the digital values meet the ON conditions), in this case between 13 and 14. Since the digital value of the input signal Cin1 is equal to the peak, the second detection circuit 163 generates the ON signal for the corresponding touch sensor (i.e., the first touch sensor 111). In addition, since the digital values of the input signals Cin2 and Cin3 are less than the secondary value (e.g., 13), the second detection circuit 163 generates the OFF signal for the corresponding touch sensors (i.e., the second and third touch sensors 112, 113). Accordingly, the second detection circuit 163 correctly determines that the first touch sensor 111 was touched since the digital values corresponding to the second and third touch sensors 112, 113 (e.g., 12 and 9) is less than the secondary threshold value (e.g., 13).

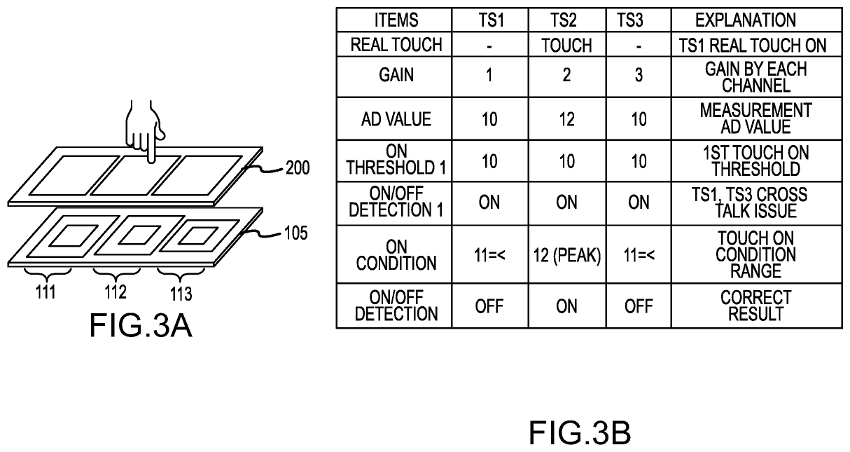

Similarly, and referring to FIGS. 1A-1B and 3A-3B, the finger approaches/touches the second touch sensor 112, and in this example, the first detection circuit 160 indicates that all three touch sensors have been touched. The second detection circuit 163 determines the value with the highest magnitude (e.g., 12). The MCU 120 may set a peak value equal to the highest magnitude (e.g., 12) and set a secondary value (e.g., 11) based on the peak value. The second detection circuit 163 then compares the digital values to the peak value and the secondary value and correctly determines that the second touch sensor 112 was touched since the digital values corresponding to the first and third touch sensors 111, 113 (e.g., 10) is less than the secondary threshold values (e.g., 11).

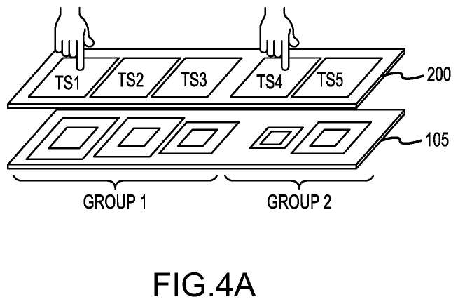

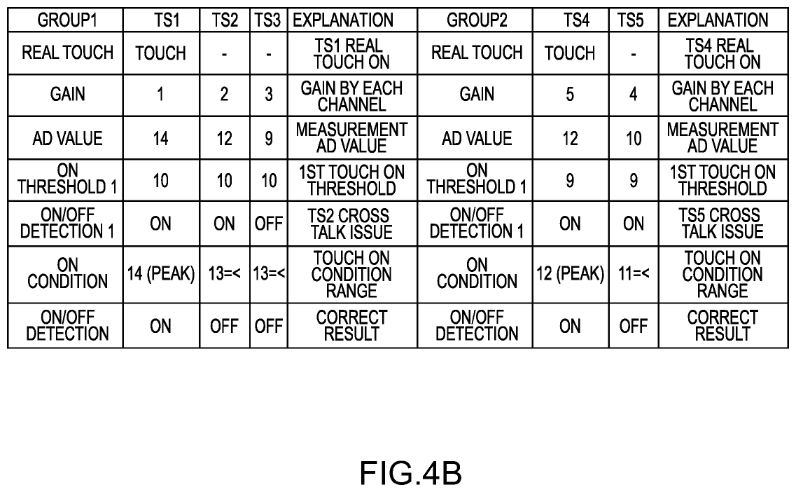

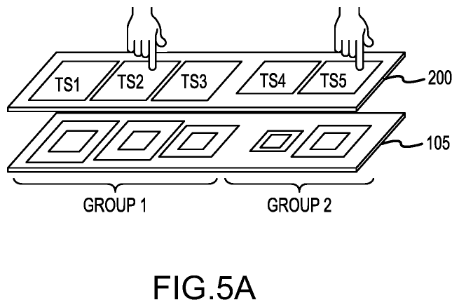

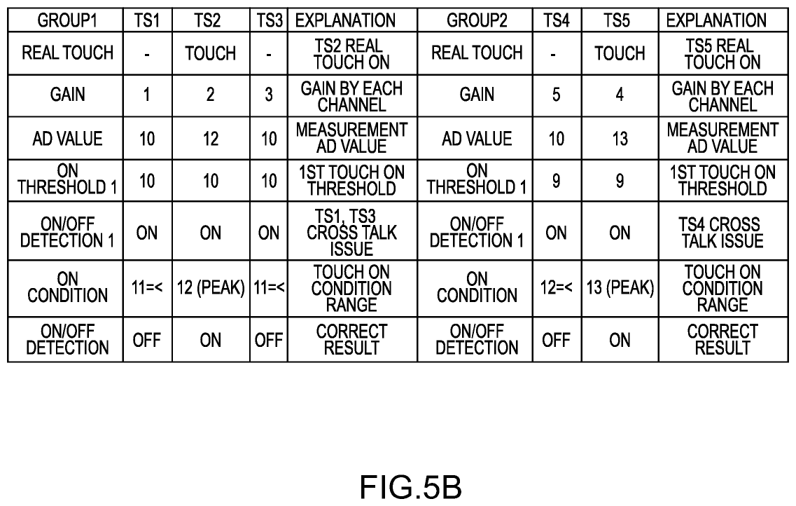

In a second exemplary operation and referring to FIGS. 1A-1B, 4A-4B, and 5A-5B, the sensing circuit 110 may simultaneously monitor more than one touch pad 105 or more than one group of touch sensors, wherein each touch sensor is associated with an individual digital value. The digital values are simultaneously compared to various threshold values, where a first group of touch sensors (e.g., TS1, TS2, TS3) is compared to a first threshold and a second group of touch sensors (e.g., TS4, TS5) is compared to a second threshold to determine whether a touch event has occurred. Those digital values that correspond to a touch event (ON) are then compared to a number of ON conditions with various values. For example, the second detection circuit 163 may determine if any of the first group of digital signals meets a first set of ON conditions and may determine if any of the second group meets a second set of ON conditions. If a digital value does not meet the ON condition criteria, an OFF signal (which represents a non-touch event) is generated, and if the digital value does meet the ON condition criteria, then an ON signal (which represents a touch event) is generated. According to the present operation, the MCU 120 may determine the ON condition criteria by setting a peak value first and then setting the secondary values based on the peak value, wherein the secondary values are less than the peak value. In the present operation, a single sensing circuit 110 may be connected to the multiple groups of touch sensors and/or multiple touch pads 105 to perform touch detection, set and apply multiple gain values, set multiple threshold values and/or ranges of values, and the like.

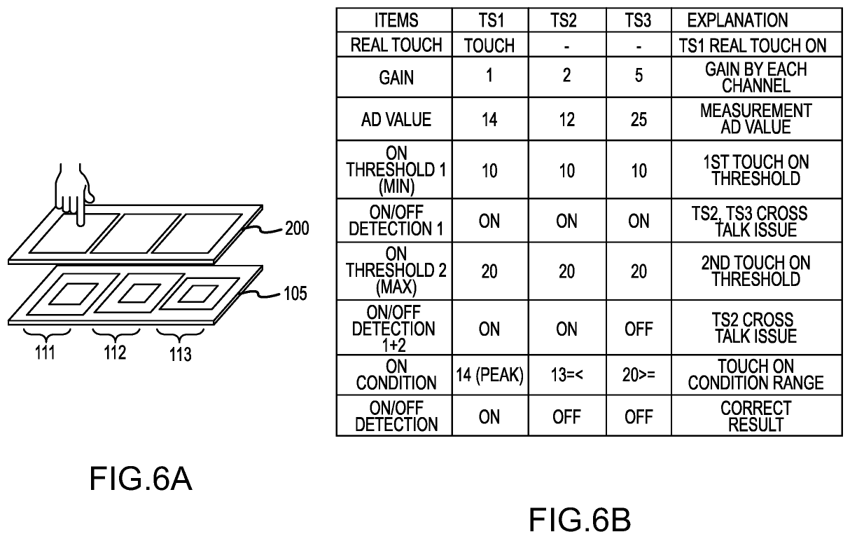

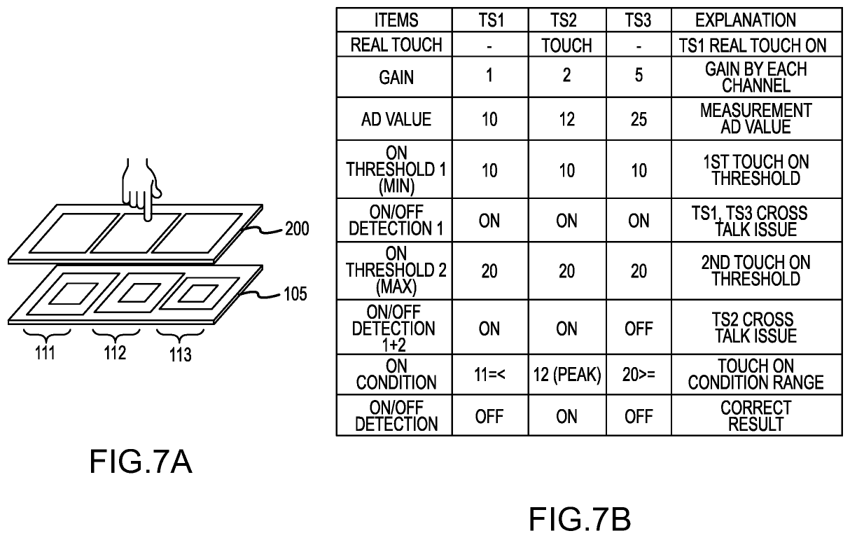

In a third exemplary operation and referring to FIGS. 1A-1B, 6A-6B, and 7A-7B, the first detection circuit 160 may compare the digital values to both a minimum threshold and a maximum threshold. According to the present operation, the maximum threshold may be set to remove signals that may be assumed to represent external noise. In the present operation, the digital values may be compared to the minimum threshold and then compared to the maximum threshold. The second detection circuit 163 may then determine if the digital values meet a set of ON conditions with varying criteria, such as a peak value and secondary values.

One of the secondary values may be selected based on the maximum threshold and the other secondary value may be based on the peak value. If the digital value is above the minimum threshold, below the maximum threshold, and meets the ON condition criteria, then the second detection circuit 163 generates an ON signal to represent a touch event. If the value does not meet all three criteria, the second detection circuit 163 generates an OFF signal to represent a non-touch event. According to the present operation, the MCU 120 may determine the ON condition criteria (range of values) by setting the peak value first and then setting the secondary values based on the peak value, wherein the secondary values are less than the peak value.

The particular implementations shown and described are illustrative of the technology and its best mode and are not intended to otherwise limit the scope of the present technology in any way. Indeed, for the sake of brevity, conventional manufacturing, connection, preparation, and other functional aspects of the apparatus may not be described in detail. Furthermore, the connecters and points of contact shown in the various figures are intended to represent exemplary physical relationships between the various elements. Many alternative or additional functional relationships or physical connections may be present in a practical system.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology.

1. A sensing circuit configured to connect to a touch sensor, comprising:
an amplifier configured to receive an input signal from the touch sensor and transform the input signal to a voltage signal;
an analog-to-digital converter connected to the amplifier and configured to convert the voltage signal to a digital value;
a first detection circuit configured to determine a touch event according to the digital value and a first criteria; and
a second detection circuit configured to determine the touch event according to the digital value and a second criteria.

2. The sensing circuit of claim 1, wherein the first criteria comprises a predetermined first threshold value.

3. The sensing circuit of claim 2, wherein the first detection circuit is configured to compare the digital value to the first threshold value.

4. The sensing circuit of claim 3, wherein the first detection circuit generates an ON signal if the digital value is greater than the first threshold value.

5. The sensing circuit of claim 1, wherein the second criteria comprises a peak value that is equal to the digital value with the highest magnitude.

6. The sensing circuit of claim 5, wherein the second criteria comprises a secondary value that is less than the peak value.

7. The sensing circuit of claim 6, wherein the second detection circuit is configured to compare the digital value to at least one of the peak value and the secondary value.

8. The sensing circuit of claim 7, wherein the second detection circuit generates an ON signal if the digital value is greater than the secondary value and less than or equal to the peak value.

9. A method of improving touch detection in a capacitive touch sensor, comprising:
receiving a plurality of signals from the touch sensor;
generating a plurality of digital values comprising:
transforming each signal to a voltage signal; and
converting each voltage signal to digital value;
comparing each digital value to a first threshold value;
comparing each digital value to at least a second value and a third value;
identifying one digital value, from the plurality of digital values, that corresponds to an actual touch based on the comparisons to:
the first threshold value;
the second value; and
the third value; and
identifying at least one digital value, from the plurality of digital values, that corresponds to cross talk based on the comparisons to:
the first threshold value;
the second value; and
the third value.

10. The method of claim 9, wherein the second value is equal to the digital value with the highest magnitude.

11. The method of claim 10, wherein the third value is less than the second value.

12. The method of claim 9, further comprising comparing each digital value to a fourth value that less than the digital value with the highest magnitude.

13. The method of claim 9, wherein identifying one digital value that corresponds to the actual touch comprises:
determining if the digital value is greater than the first threshold;
determining if the digital value is greater than the third value; and
determining if the digital value is less than or equal to the second value.

14. The method of claim 9, wherein identifying at least one digital value that corresponds to cross talk comprises:
determining if the at least one digital value is greater than the first threshold; and
determining if the at least one digital value is less than the third value.

15. A system, comprising:
a touch pad comprising a plurality of capacitive touch sensors, each capacitive touch sensor configured to generate a sensor signal;
a sensing circuit connected to the touch sensor and comprising:
an amplifier connected to the touch sensor and configured to transform each sensor signal to a voltage signal;
an analog-digital converter (ADC) connected to the amplifier and configured to convert each voltage signal to a digital value; and
a detection circuit connected to the ADC and configured to:
compare each digital value to a minimum threshold value;
compare each digital value to a set of secondary values; and
generate one of a first signal and a second signal for each digital value according to the comparisons to the minimum threshold value and the set of second values; and
a processing circuit responsive to the sensing circuit.

16. The system of claim 15, further comprising comparing each digital value to a maximum threshold value.

17. The system of claim 15, wherein the detection circuit generates the first signal if the digital value is greater than the minimum threshold value and less than the maximum threshold value.

18. The system of claim 15, wherein the set of second values comprises a peak value that is equal to the digital value that has the highest magnitude of the digital values that are less than the maximum threshold.

19. The system of claim 18, wherein the set of secondary values further comprises a second value that is less than the peak value.

20. The system of claim 19, wherein the detection circuit generates the second signal if the digital value is:
less than the second value; or
greater than the maximum threshold value.
